(19) United States
(12) Patent Application Publication
(10) Pub. No.: US 2008/0182728 A1
(43) Pub. Date: Jul. 31, 2008

(54) Walk Assist

(76) Inventor: Jack Lester Glasscock, McNeil, AR (US)

Correspondence Address: JAMES M. VAN BUSKIRK, PA, 111 EAST GROVE ST., EL DORADO, AR, 71730, US

(21) Appl. No.: 11/669,329

(22) Filed: Jan. 31, 2007

(51) Int. Cl. A61H 3/04

(52) U.S. Cl. 482/68

(57) ABSTRACT

A walker used in tandem with a sling system (sling) that is made up of a series of bungi-cords, steel hooks, adjustable plastic hooks, a nylon strap and a plastic support piece. The walker and sling allow the invalid to keep their entire body weight off of the walker when it is moved. It also helps keep the invalid's injured foot off of the floor so that no weight is put on it. A short piece of bungi-cord with small hooks on either end is looped around the top of one side of the walker and the hook on the looped end is hooked to the looped bungi-cord. The other small steel hook connected to the short bungi-cord hooks to a steel hook that is attached to a long bungi-cord running to an adjustable hook that is hooked to a loop that holds a nylon strap with a piece of plastic glued in it for added support. The nylon strap is where the invalid places their foot. A short bungi-cord with small hooks can be used to hold the foot in the shoe support. The adjustable hook that is hooked to the loop is connected to a second piece of long bungi-cord that runs to the other top side of the walker where it ends in a second plastic adjustable hook that is hooked to a small steel hook, short bungi-cord and another small hook. The short bungi-cord is looped around the top bars of the walker and the hook is hooked to the top cross support bar. The second long bungi-cord can be adjusted at the bottom adjustable hook or top adjustable hook depending on the height of the invalid.

### BACKGROUND FOR THE INVENTION

The invention is related to the Medical Device field, particularly to invalids that require the use of a walker and have one leg that is immobile.

Walkers of all types are known to those in the ordinary skill of the art. But what none of the inventors of walkers has done is to incorporate a method for allowing the invalid to keep pressure off the “bad” leg while moving the walker. This invention uses a sling system in tandem with a walker to assist the invalid in moving the walker while standing on his good leg. After the walker is placed in its new position, the sling pulls the immobile leg forward, thus allowing the invalid to repeat the process.

### BACKGROUND OF PRIOR ART

Patents exist that describe the use of slings for many things but none of them describe a method of use where a sling is used in tandem with a walker to aid an invalid with only one good leg to move the walker with less effort than if he did not have the assistance of the sling. Cardenas describes an invention in U.S. Pat. No. 7,255,666 that is a “Multifunction” apparatus. This patent does not describe a way to allow the person using is to be mobile. Reiter describes a suspended trimming device in U.S. Pat. No. 5,885,190 to assist a person in keeping fit; once again this device is stationary.

Coates et al. describes a stationary device in U.S. Pat. No. 5,704,882 that allows a person to sit and bounce as part of an exercise program. Malynowsky describes a stationary device in U.S. Pat. No. 5,399,139 for activating the circulation of the lymphatic system in the legs of the user. Neufeld describes a resilient sling in U.S. Pat. No. 4,327,909 for supporting a fractured arm of a wearer.

### BRIEF SUMMARY OF THE INVENTION

An invalid walker that uses a sling system consisting of bungi-cords and hooks that increases the ease of movement for the invalid by helping to keep the bad leg or foot off of the ground while moving the walker.

### BRIEF DESCRIPTION OF THE DRAWINGS

FIG. 1 shows an oblique view of the walker and sling system.

FIG. 2 shows an oblique view of the walker by itself.

### DETAILED DESCRIPTION OF THE INVENTION

The apparatus described here in is like nothing else invented to date. Although numerous walker and sling systems have been invented none of them have been put together. This invention puts a walker and sling system together for the purpose of increasing the ease of the movement that an invalid with a bad leg or foot would have without the assistance of the sling.

Using the walker and sling system in tandem allows the invalid to easily move the walker and injured leg. Using the walker normally, the person's full body weight would be on the walker, making the walker difficult to move. Then after the walker is moved, the invalid would have to drag the injured leg back to the equilibrium position for the next move. With the sling and walker system, the person would only have part of their body weight on the walker making the walker easier to move and the sling would pull the injured leg up to the equilibrium point for the next move.

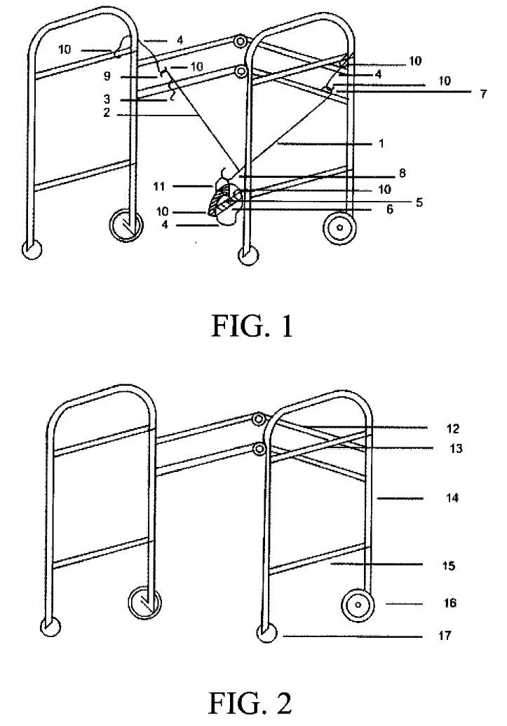

The system functions in the following manner. A walker shown in FIG. 2 is installed with the sling system. The combination is shown in FIG. 1. The sling system is set up depending on which leg is bad. Starting on the side with the bad leg, a short bungi-cord segment with small hooks (10) on either end is looped around the top cross support (12) that is located on the same side as the bad leg. The hook (10) that is on the looped end is hooked to the bungi-cord (4) securing the sling to the u-shaped frame (14) that is on the bad leg side. The other hook (10) is hooked to a plastic coated steel fixed hook (7) that in turned is connected to one end of a long length of bungi-cord (1). The other end of the bungi-cord is connected to a plastic adjustable hook (8) that is hooked to a loop (11) that holds a nylon strap (5) with a glued plastic insert (6) that makes up a shoe support. The plastic adjustable hook (8) is also connected to a second long piece of bungi-cord (2) that runs to the other side of the walker (the good foot side). The other end of the bungi-cord (2) is connected to a second plastic adjustable hook (9) where the bungi-cord (2) can be adjusted depending on the height of the invalid. The remainder of the bungi-cord (2) that goes through the hook (9) is surplus cord (3). The hook (9) is hooked to a small hook (10) that is connected to one end of a short bungi-cord (4) that in turn has a small hook (10) on the other end of the bungi-cord (4). The bungi-cord (4) is looped around the front the good leg side u-shaped frame (14) above the top cross support (12) and the hook is then hooked to the top cross support (12).

The walker and sling are used in the following manner: if the persons right foot is injured such that no weight should be placed on it, the sling system described above will run from (looking at FIG. 1) the right side of the walker to the left side of the walker. The invalid will place his foot in the shoe support (5) and (6) that can be held in the support by a small bungi-cord (4) and hook (10) system attached to the support. Starting at a point of equilibrium, the invalid will move the walker. When the walker is in its new position, the invalid will place his weight on the walker and the sling will pull the bad foot forward while the invalid moves his good leg to the new equilibrium position. Then the process repeats itself.

What is claimed is:

1. A walker comprising:
a. two u-shaped side frames (14) each frame having a rear stationary foot (17) and a front wheel (16),
b. each u-shape frame (14) includes a top cross support (12) and a bottom cross support (15),
c. the two unshaped frames (14) are connected with two collapsible cross bars (13).

2. The apparatus described in claim 1 where the two u-shaped frames (14) are connect by two rigid cross bars.

3. The apparatus of claim 1 enhanced by the addition of a sling system comprised of:
a. a short bungi-cord segment (4) that is attached to small steel hooks (10) on either end,
b. one end of the bungi-cord (4) and one hook (10) are looped around the top cross support (12) of one of the u-shaped frames (14) and then that hook (10) is hooked to the bungi-cord (4),
c. the hook (10) on the other end of the bungi-cord (4) is hooked to a plastic coated steel fixed hook (7),
d. the plastic coated steel fixed hook (7) is connected to one end of a long bungi-cord segment (1),
e. the other end of the long bungi-cord segment (1) is connected to a plastic adjustable hook (8),
f. the plastic adjustable hook (8) is also attached to a second long bungi-cord segment (2),
g. the other end of the second long bungi-cord segment (2) is hooked to a second plastic adjustable hook (9),
h. the surplus cord (3) the remainder of the second long bungi-cord (2) thread through the second plastic adjustable hook and is used for height adjustment,
i. the second plastic adjustable hook (9) is hooked to a small hook (10),
j. the small hook (10) is attached to a short piece of bungi-cord (4) connected to a small hook (10) at the other end,
k. the short bungi-cord (4) is looped around the front end of the opposite u-shaped frame (14) above the top cross support (12) and the hook (10) is hooked to the top cross support,
l. the plastic adjustable hook (8) is hooked to a loop (11) that holds a nylon strap (5),
m. the nylon strap (5) along with a glued in plastic liner (6) makes a foot or shoe support,
n. a piece of short bungi-cord (4) with hooks (10) on either end are hooked to either end of the shoe support to hold the foot or shoe from slipping.

4. The apparatus of claim 2 enhanced by the addition of a sling system comprised of:
a. a short bungi-cord segment (4) that is attached to small steel hooks (10) on either end,
b. one end of the bungi-cord (4) and one hook (10) are looped around the top cross support (12) of one of the u-shaped frames (14) and then that hook (10) is hooked to the bungi-cord (4),
c. the hook (10) on the other end of the bungi-cord (4) is hooked to a plastic coated steel fixed hook (7),
d. the plastic coated steel fixed hook (7) is connected to one end of a long bungi-cord segment (1),
e. the other end of the long bungi-cord segment (1) is connected to a plastic adjustable hook (8),
f. the plastic adjustable hook (8) is also attached to a second long bungi-cord segment (2),
g. the other end of the second long bungi-cord segment (2) is hooked to a second plastic adjustable hook (9),
h. the surplus cord (3) the remainder of the second long bungi-cord (2) thread through the second plastic adjustable hook and is used for height adjustment,
i. the second plastic adjustable hook (9) is hooked to a small hook (10),
j. the small hook (10) is attached to a short piece of bungi-cord (4) connected to a small hook (10) at the other end,
k. the short bungi-cord (4) is looped around the front end of the opposite u-shaped frame (14) above the top cross support (12) and the hook (10) is hooked to the top cross support,
l. the plastic adjustable hook (8) is hooked to a loop (11) that holds a nylon strap (5),
m. the nylon strap (5) along with a glued in plastic liner (6) makes a foot or shoe support,
n. a piece of short bungi-cord (4) with hooks (10) on either end are hooked to either end of the shoe support to hold the foot or shoe from slipping.
